(19) United States
(12) Patent Application Publication
(10) Pub. No.: US 2004/0190902 A1
(43) Pub. Date: Sep. 30, 2004

(54) WDM network system and WDM node for use therein

(75) Inventor: Naofumi Tamai, Kawasaki (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 10/821,922

(22) Filed: Apr. 12, 2004

Related U.S. Application Data
(63) Continuation of application No. PCT/JP01/09557, filed on Oct. 31, 2001.

(51) Int. Cl. H04J 14/00

(52) U.S. Cl. 398/68

(57) ABSTRACT

Effective use of bandwidth resources such as wavelengths and paths are facilitated and the release of the fixed relationship of one client to one client is enabled by a WDM (Wavelength Division Multiplexed) network system executing automatic wavelength control using IP addresses. The WDM (Wavelength Division Multiplexed) network system includes an optical wavelength division multiplexed (WDM) transmission path, a plurality of sub-networks each accommodating a client, and a plurality of WDM nodes each corresponding to each of the plurality of sub-networks respectively and connected with the optical wavelength division multiplexed transmission path, the plurality of WDM nodes each including a wavelength converting unit for controlling oscillation frequencies depending on a destination address for which the communication destination is identified by an IP address and a cross-connecting unit for cross-connecting the route directed to an adjacent WDM node for connecting with the communication destination.

### TECHNICAL FIELD OF THE INVENTION

The present invention relates generally to a data network system based on an Internet protocol (IP) and, more particularly, to a WDM (Wavelength Division Multiplexed) network system executing automatic wavelength control using IP addresses, as well as to a WDM node for use in the network system.

### PRIOR ART

In a WDM (Wavelength Division Multiplexed) network system, a variable-wavelength light source enables one (1) same module to oscillate and output any one (1) desired wavelength among a plurality of wavelengths.

Thereby, it is not necessary to prepare a standby optical module for each of the wavelengths and it is not either necessary to purchase and add any new optical module even when a need to change the wavelengths used in the network plan arises. From these facts, construction of a network at the minimal cost is enabled. Furthermore, the number of the wavelengths capable of being selected in one (1) module is increasing as the technology advances.

FIG. 1 illustrates the conventional settings of wavelengths and paths in a WDM network and the settings of address routing at a client.

For example, the case where data is transmitted from a contents server Sa in a sub-network A to a contents server Sb in a sub-network B is considered.

In this case, in a wavelength/path controlling system comprising a WDM node 1 and the sub-network A shown in FIG. 2, a client in the sub-network A is in the territory of the WDM node 1 and the sub-network A as whole is assigned with an address “a”.

As shown in FIG. 2, according to the routing with an (IP) address, data from the contents server Sa is sent in the sub-network A from a router Ra1 connected to the contents server Sa to a router Rag.

The one (1) to which the router Rag is to deliver the same data next is a router Rbg in the sub-network B. However, the router Rag can not know that the gateway of the sub-network B is the router Rbg, until a wavelength path between the router Rag and the router Rbg on a WDM route has been defined and a routing protocol is transacted between the router Rag and the router Rbg.

Furthermore, even when it has been defined at the router Rag in advance that the gateway of the sub-network B is the router Rbg, communication with the router Rbg can not be started until a wavelength path has been defined by an operator.

That is, until today, specific wavelength/path have been selected from the unused wavelengths/paths by an operator and setting operation has been executed for a WDM node. Therefore, even when a destination address is defined at a client, the client can not communicate with destination client until a man has manually completes the above wavelength/path settings for the WDM node. As above, the defining of the destination address of a client and the wavelength/path settings for a WDM node are independent from each other.

Furthermore, even when the wavelength/path settings defined for the WDM node is fixed and it is assumed that no traffic is occurred, the state is left as it is until it is released by an operator manually. Thereby, the wavelength/path can only be used for communication for fixed relation of one (1) client to one (1) client.

### SUMMARY OF THE INVENTION

It is therefore the object of the present invention to provide a method and a system for automatic wavelength control based on IP addresses in a network system, that enable speedup of setting of wavelength/path and reduction of manual operation. Furthermore, another object of the present invention is to provide a WDM network system by automatic wavelength control and a WDM node for use therein, that facilitate the effective use of band resources such as wavelengths and paths and enable releasing of fixed one-to-one relationship between clients.

According to the WDM network system and a WDM node for use therein, that achieve the above objects of the present invention, the WDM node detects and defines wavelengths and paths on an autonomous basis in conformity with the destination address of traffic. The wavelengths and paths are defined and deleted in response to occurrence and disappearance of traffic. Therefore, wavelengths and paths can be used for other traffic when the traffic on the network is not crowded.

Furthermore, since a wavelength and a path are set for each traffic, it is possible to send data from the same originator client to a plurality of addresses and therefore, broadcasting and interactive communication of one-to-multiple or multiple-to-multiple can be realized.

A WDM network system according to a first aspect of the present invention includes an optical wavelength division multiplexed (WDM) transmission path; a plurality of sub-networks each accommodating a client; and a plurality of WDM nodes each corresponding to each of the plurality of sub-networks respectively and connected with the optical wavelength division multiplexed transmission path, wherein each of the plurality of WDM nodes includes a wavelength converting unit for controlling oscillation frequencies in conformity with a destination address for which the communication destination is identified by an IP address; and a cross-connecting unit for cross-connecting the route directed to an adjacent WDM node for connecting with the communication destination.

The WDM network system according to a second aspect of the present invention is characterized in that in the first aspect, each of the WDM nodes includes a routing table for storing the IP address of the corresponding sub-network, a WDM node of an upper order of the sub-network, a cross-connection ID identifying the path, a wavelength used and information of the WDM node to which the main signal is first sent when reaching the target sub-network using a predetermined path, and that the control of the oscillation frequency by the wavelength converting unit and the cross-connecting of the route are conducted by referring to the routing table.

The WDM network system according to a third aspect of the present invention is characterized in that in the second aspect, when an IP address of a sub-network in which a client is accommodated is notified from the client issuing a request for connection, the corresponding node registers the IP address of the sub-net work into the routing table, and that each WDM node exchanges the IP address information of the sub network retained in the routing table with adjacent nodes.

The WDM network system according to a fourth aspect of the present invention is characterized in that in the first aspect, the wavelength converting unit executes one-to-multiple communication by converting a wavelength into a plurality of wavelengths in response to a request for connection from one (1) client.

The WDM network system according to a fifth aspect of the present invention is characterized in that in the second aspect, a plurality of selectable paths are set in a cross-connection ID identifying the path of the routing table, with the priority being registered for each path.

The WDM network system according to a sixth aspect of the present invention is characterized in that in the fifth aspect, the priority is set based on the quality of the WDM signal at the receiving terminal and can be updated in response to disconnection or recovery of the path.

The features of the present invention will become more apparent from the embodiments of the present invention which will be described with reference to the drawings which follow.

### BRIEF DESCRIPTION OF THE DRAWINGS

FIG. 1 illustrates the conventional settings of wavelengths and paths in a WDM network and the settings of address routing at client;

FIG. 2 shows a wavelength/path controlling system comprising a WDM node 1 and the sub-network A;

FIG. 3 shows an example of the composition of the WDM node 1;

FIG. 4 shows processing steps at the WDM node 1 until a path between a sub-network A and a sub-network B has been established;

FIG. 5 shows processing steps at a WDM node 3 until a path between a sub-network A and a sub-network B has been established;

FIG. 6 shows processing steps at a WDM node 4 until a path between a sub-network A and a sub-network B has been established;

FIG. 7 is an example of the composition of a routing table;

FIG. 8 shows wavelengths/paths between WDM nodes set by executing Step 1 to Step 18 in a network composition same as in FIG. 1;

FIG. 9 shows the contents of a routing table RT in a database DB14 at each of the WDM nodes 1-4;

FIG. 10 illustrates effective use of wavelengths/paths;

FIG. 11 is an example of the composition of a WDM node enabling one-to-multiple communication, being applied with the present invention;

FIG. 12 shows one-to-multiple communication between the sub-network A and sub networks B-E;

FIG. 13 illustrates selection in response to physical conditions of a route (path); and

FIG. 14 illustrates the capability for switching to another path and continuing communication based on the selection in response to the physical conditions of the route (path) in FIG. 13 when a failure has occurred.

### DESCRIPTION OF EMBODIMENTS OF THE INVENTION

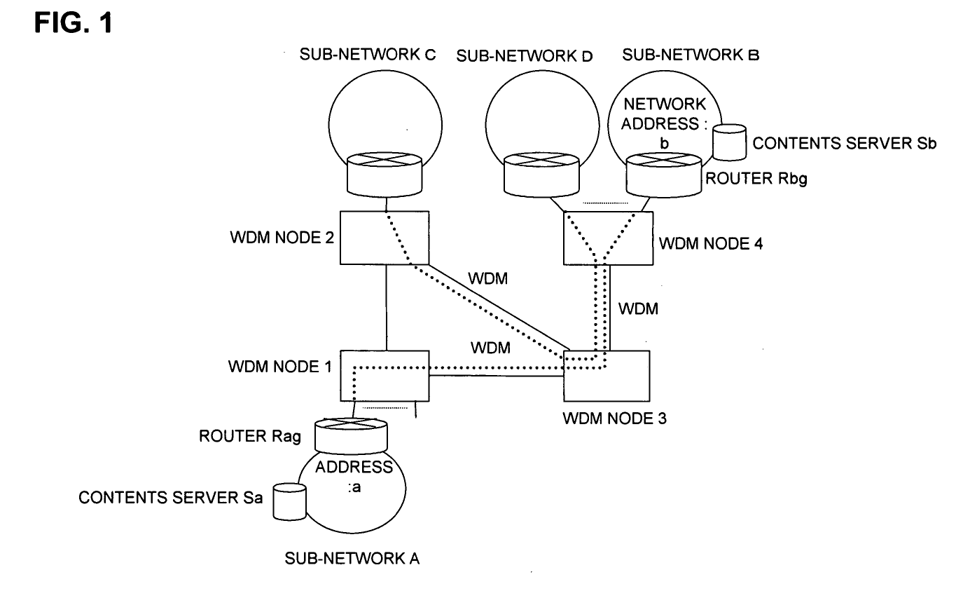

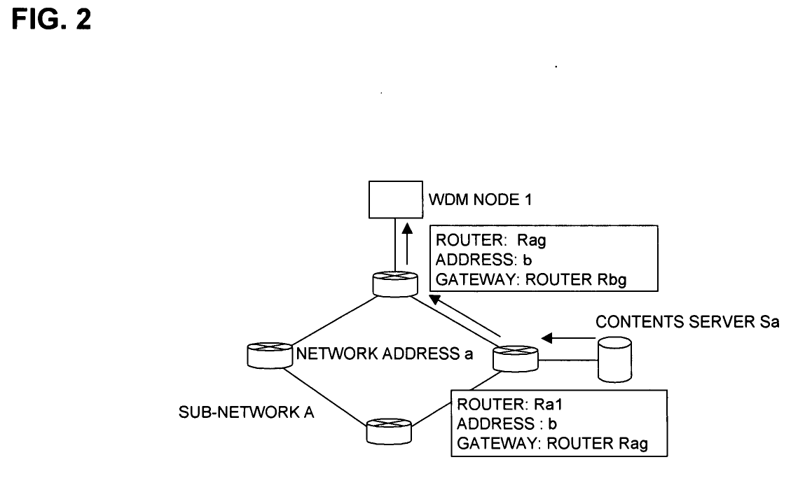

An application of the present invention will now be described utilizing again the network shown in FIG. 1.

[Autonomous Determination and Definition of Wavelengths/Paths]

In FIG. 1, when communication is made between the sub-network A and the sub-network B, a WDM (wavelength division multiplexing) technique is applied for saving the cost of the equipment and the transmission path fibers. In this case, the traffic between the sub-network A and the sub-network B occupies one (1) certain wavelength in the WDM network and transmitted following a way determined at each of the WDM nodes 1-4.

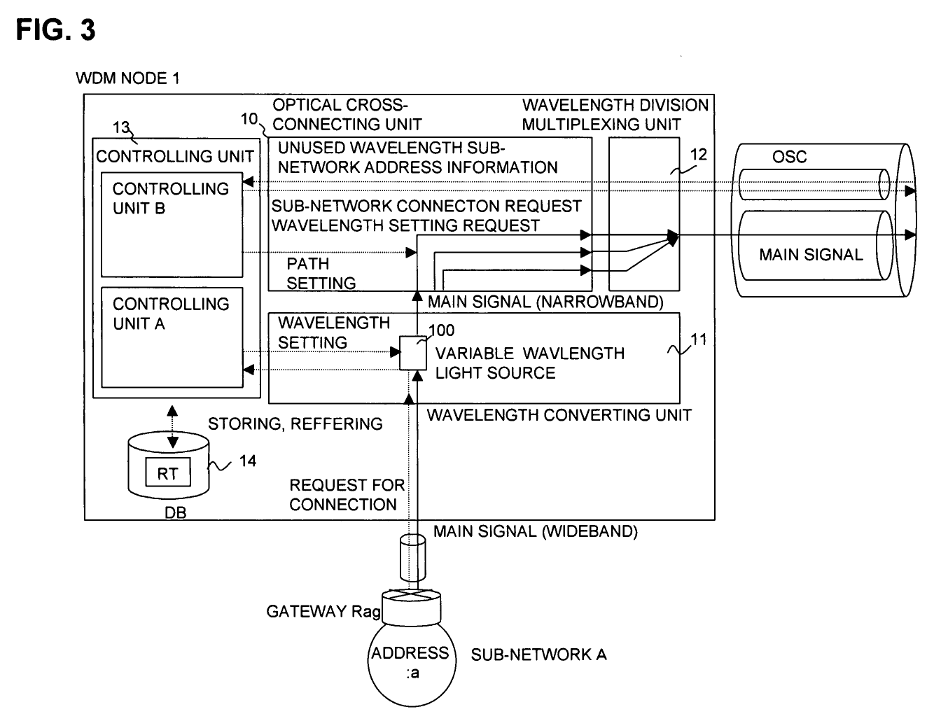

FIG. 3 is a construction example of the composition of the WDM node 1 and the WDM node 1 includes a photo cross-connecting unit 10, a wavelength converting unit 11 having a variable-wavelength light source 100, a wavelength division multiplexing unit 12, a controlling unit 13 and a database (DB) 14. Wavelength/path controlling systems of other WDM nodes 2-4 and corresponding sub-networks B-D in FIG. 1 is respectively in the same relation as the wavelengths/paths controlling system of the WDM node 1 and the sub-network A shown in FIG. 3.

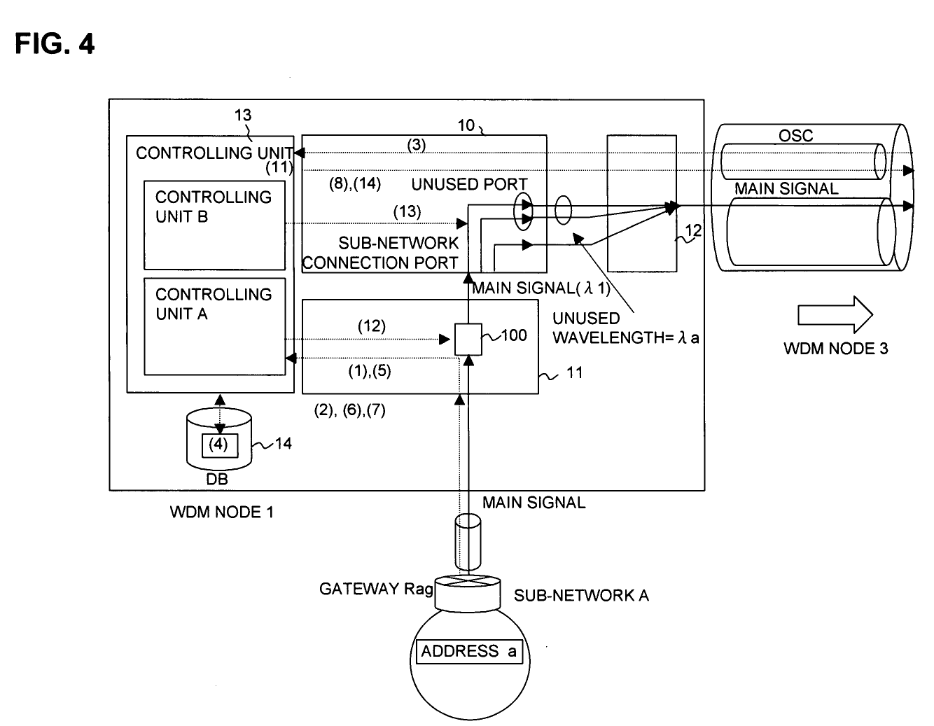

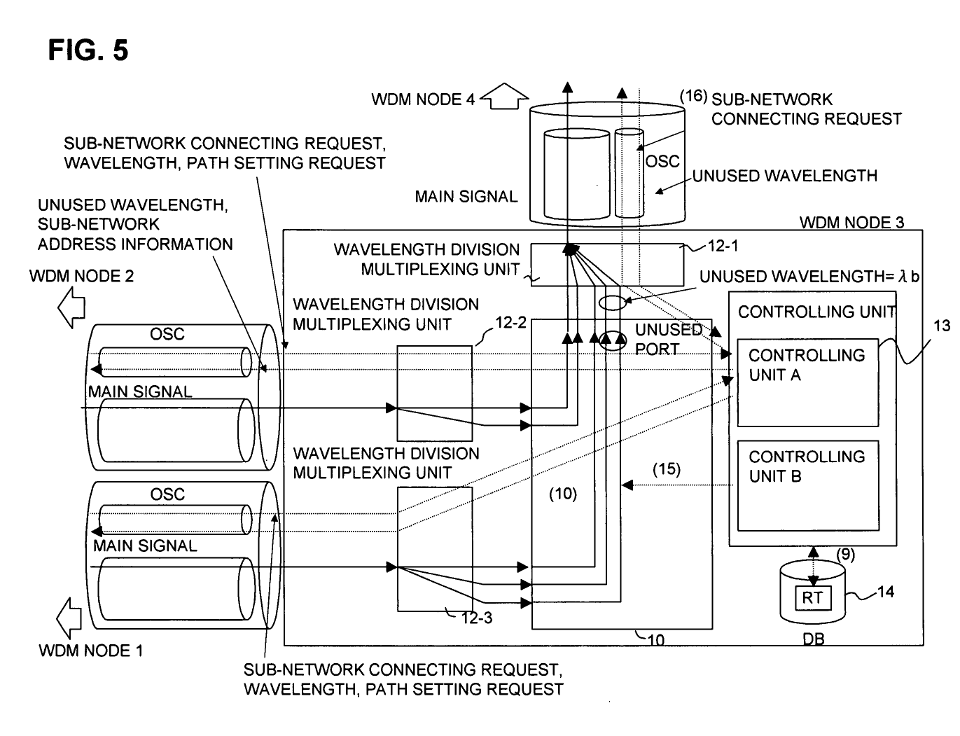

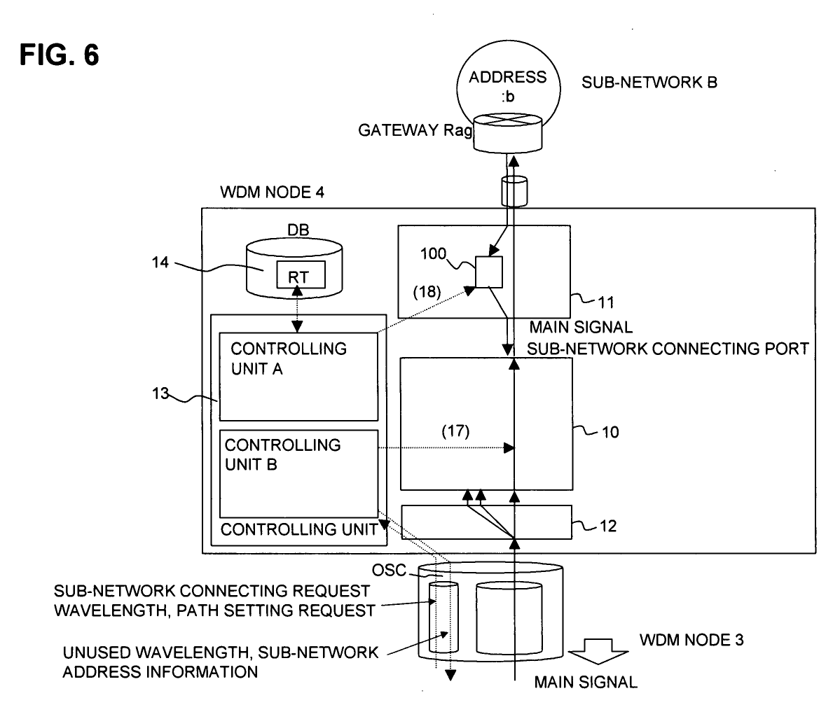

Next, the process to the establishment of a path between the sub-network A connected to the WDM node 1 and the sub-network B connected to the WDM node 4 for the case where the process is applied with the present invention will be described as follows referring to FIGS. 4-6. The following numeral denotations in parentheses shown in FIGS. 4-6 are corresponded according to the order of steps of the operation described as follows. FIG. 4 shows the process steps at the WDM node 1. FIG. 5 shows the process steps at the WDM node 3. FIG. 6 shows the process steps at the WDM node 4.

(Step 1)

In FIG. 4, a client in the sub-network A connected with the WDM node 1 notifies the WDM node 4 of its network address “a”of the sub-network A.

(Step 2)

The corresponding WDM node 1 stores the network address a notified in Step 1, in the database 14.

(Step 3)

The WDM node 1 exchanges the sub-network address information retained in Step 2 with the adjacent WDM node 2 and WDM node 3 through an optical supervisory channel OSC. The sub-network address information is also exchanged between the WDM node 3 and the WDM node 4.

(Step 4)

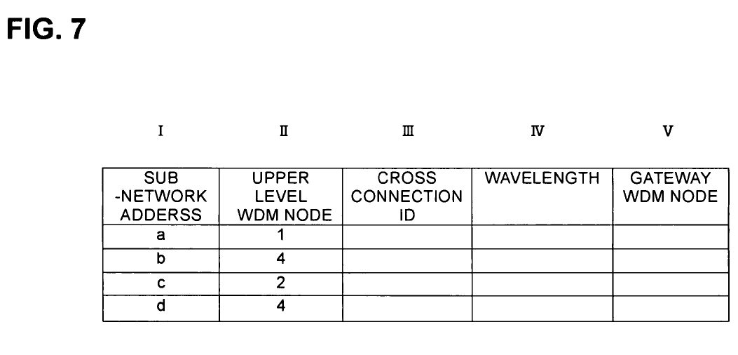

In response to Step 3, the WDM nodes 1-4 create a routing table (RT) in the database 14. FIG. 7 shows an example of a routing table.

In this routing table RT, information of sub-network address (I), upper-level WDM node (II), cross-connect ID (III), wavelength (IV) and gateway WDM node (V) is retained. The gateway WDM node (V) means the adjacent WDM node to which the main signal is first transmitted when a target sub-network is reached using a predetermined path.

(Step 5)

Next, a request for connection with the sub-network B is sent from the client in the sub-network A to the WDM node 1. The address of the sub-networks B is contained in the request.

(Step 6)

The WDM node 1 having received the request for the connection to the sub-network B in the Step 5 refers to the routing table RT in the database 14 shown in FIG. 7. Thereby, the WDM node 1 knows that the sub-network B is in the territory of the WDM node 4 and that the gateway WDM node (the node to which the main signal is first sent when communicating with the sub-network B) is the WDM node 3.

(Step 7)

Then, the WDM node 1 confirms that there is an opening (unused port) in the ports facing the WDM node 3 among the ports in the territory of the WDM node 1 itself, and there also is an unused wavelength (λa: a plurality of them are acceptable), from the routing table shown in FIG. 7.

(Step 8)

Furthermore, the WDM node 1 notifies the WDM node 3 through the OSC line that the request for connection has occurred from the sub-network A in the territory of the WDM node 1 itself to the sub-network B in the territory of the WDM node 4.

(Step 9)

The WDM node 3 (see FIG. 5) having received the notice in the Step 8 confirms that there is an opening in the ports facing the WDM node 4 among the ports of an optical cross-connecting unit 10 of the WDM node 3 itself, and there also is an unused wavelength (λb: a plurality of them are acceptable), from the routing table.

(Step 10)

Next, the WDM node 3 notifies the WDM node 1 of the unused wavelength (λb) on a port facing the WDM node 4 confirmed in the above Step 9.

(Step 11)

The WDM node 1 having received the above notice selects and determines λ=λ1 which is λa=λb=λ (see FIG. 4).

(Step 12)

Following the determination made in the above Step 11, in the WDM node 1, a controlling unit A of the controlling unit 13 sets an output wavelength of the variable-wavelength light source 100 of a wavelength converting unit 11 to λ1.

(Step 13)

Next, in the WDM node 1, a controlling unit B sets at the cross-connecting unit 10 a cross connection connecting the opening port facing the WDM node 3 confirmed in the above Step 7 with a port in the sub-network A.

(Step 14)

Next, the WDM node 1 sends to the WDM node 3 a notice carrying an order to set a cross-connection connecting a port facing the WDM node 1 with a port facing the WDM node 3 confirmed in the above Step 9, and specifying that the wavelength to be used is λ1.

(Step 15).

Following the order in the above Step 14, in the WDM node 3, the controlling unit B of a controlling unit 13 sets the cross-connection (see FIG. 5).

(Step 16)

Next, the WDM node 3 sends to the WDM node 4 an order to set a cross-connection connecting a port facing the WDM node 3 with a B port of the sub-network B, and an order to set the wavelength to be used is λ1.

(Step 17)

Following the above order, in the WDM node 4 shown in FIG. 6, the controlling unit B sets the cross-connecting unit 10.

(Step 18)

Furthermore, the controlling unit A of the controlling unit 13 sets the output wavelength of the variable-wavelength light source 100 in the wavelength converting unit 11, to λ1.

By the above operation, the establishment of the communication path between the sub-network A connected with the WDM node 1 and the sub-network B connected with the WDM node 4, and the determination of the wavelength to be used are executed autonomously.

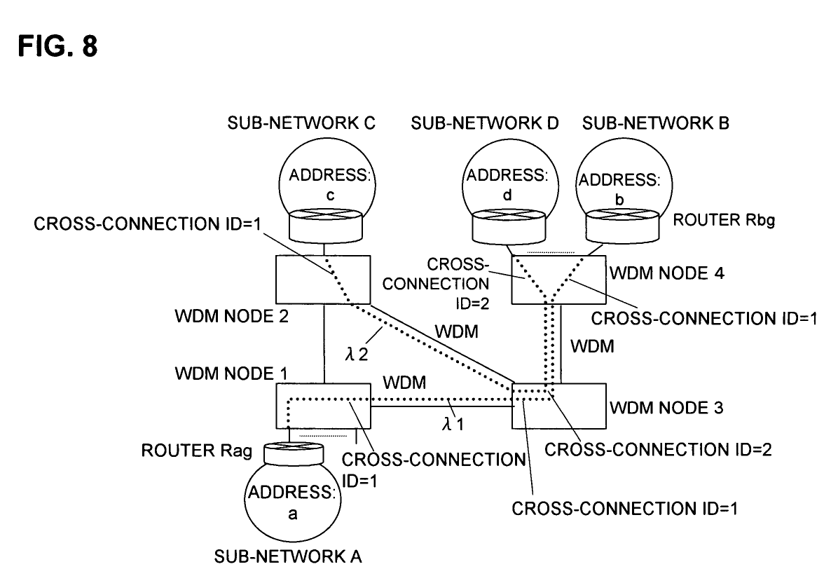

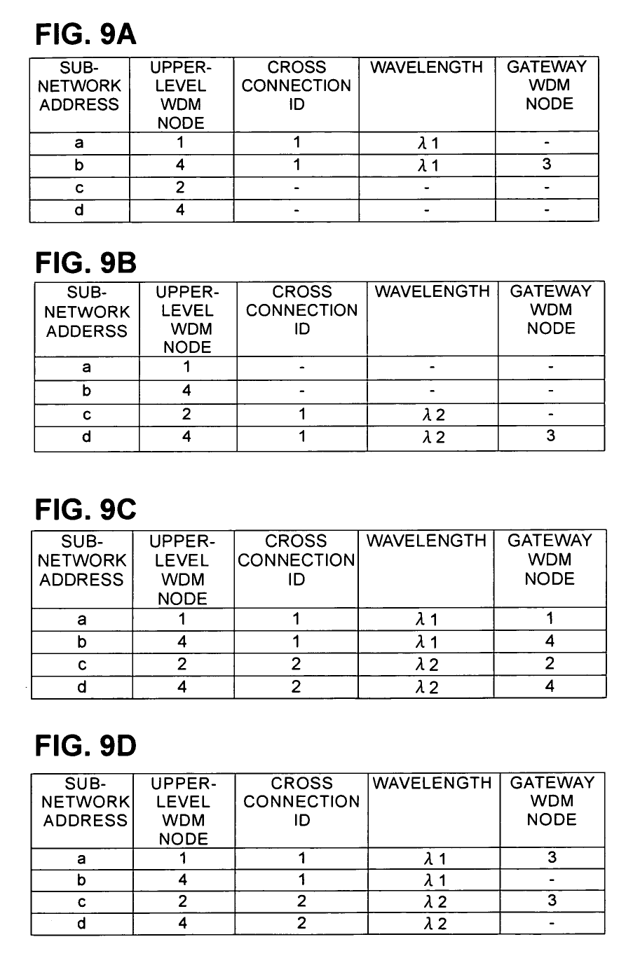

By executing the above Steps 1-18, in the same network composition as shown in FIG. 1, the wavelength and the path are set between the WDM nodes shown in FIG. 8. The contents of the routing table RT in the database DB14 for each of the WDM nodes 1-4 in this case are as shown in FIG. 9A-9D.

[Defining and Deleting of Wavelength and Path in Response to Occurrence and Disappearance of Traffic]

Here, in the conventional method in which the wavelength and the path are set in advance by an operator, the definition of the wavelength/path has to be fixed. Therefore, also for the services offered to the customers by the operator, a service in which a wavelength is lent connecting between two (2) places can only be considered.

However, according to the present invention in which a WDM node autonomously sets wavelengths/paths in cooperation with clients in its territory, it is possible to change flexibly the settings of wavelengths/paths in response to occurrence/disappearance of traffic.

For example, conventionally, once a wavelength and a path between the sub-networks A and B are defined as shown in FIG. 8, communication between the sub-network and another sub-network can not be made.

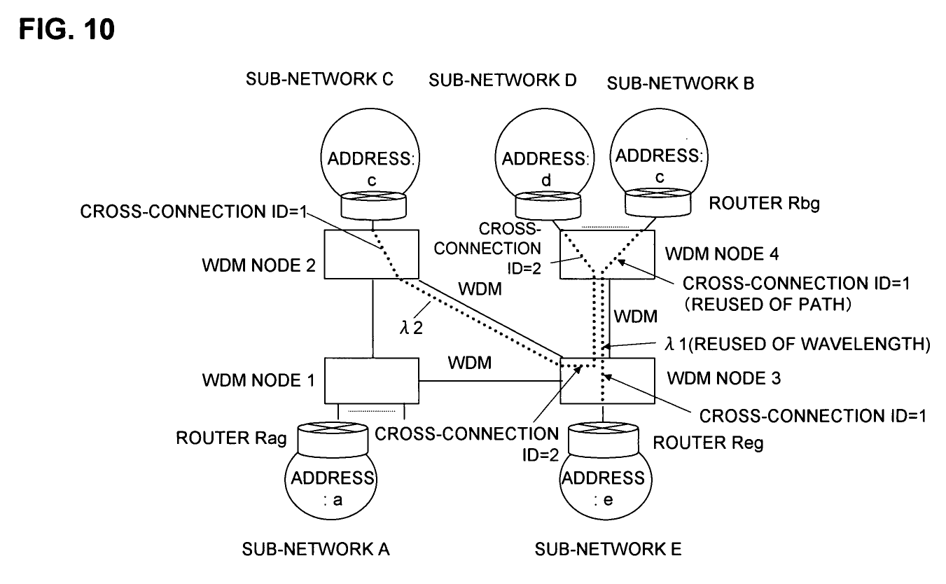

However, according to the present invention, when traffic between the sub-networks A and B has occurred earlier and, after it has disappeared, traffic between the sub-network B and another sub-network E occurs as shown in FIG. 10, it is possible to use the cross-connection (path) ID1 and the wavelength λ1 used for the traffic between the sub-networks A and B at the WDM node 4, again for the traffic between the sub-networks B and E. Thereby, effective use of wavelengths/paths resources can be carried out.

To this end, after having transmitted necessary data, a, client (router Rag) facing the sub-network A send a signal indicating the completion of transmission to the WDM node 1. Based on this, the controlling unit A controlling wavelengths and the controlling unit B controlling settings of paths in the controlling unit 13 of the WDM node 1 respectively release the wavelength and the path having been used between the sub-networks A and B. At the same time, the units A and B also transmit orders for releasing of the wavelength and the path to the adjacent WDM node 3.

Similarly, the WDM node 3 transmits an order for releasing of the wavelength and the path to the WDM node 4 and releasing of the wavelength and the path throughout the sections of the sub-networks A and B is executed.

Thereafter, the WDM node 3 receives the request for connecting from the router Reg attached to the sub-network E to the router Rbg of the sub-network B and, following the above-described Steps 1 to 18, defines a wavelength and a path between the sub-networks B and E. Thereby, as shown in FIG. 10, communication between the sub-network E and the sub-network B becomes possible.

[Communication between One Client to Multiple and Multiple to Multiple]

Furthermore, in the progress of employment of multi-media and broad-bands from now on, communication is carried out not only one (1) to one (1) but also one (1) to multiple and multiple to multiple. In addition, the size of data respectively has become drastically large due to image transmission etc. and, therefore, a state is expected, where each of the traffic occupies one (1) wavelength of a WDM network.

As a specific application, streaming broadcasting, a TV conference/TV telephone connecting a plurality of places, a national referendum, a national census etc. are considered.

The invention enables executing of setting wavelengths and paths for such one (1)-to-multiple and multiple-to-multiple communication. This will be described as follows.

(a) One-to-Multiple Communication

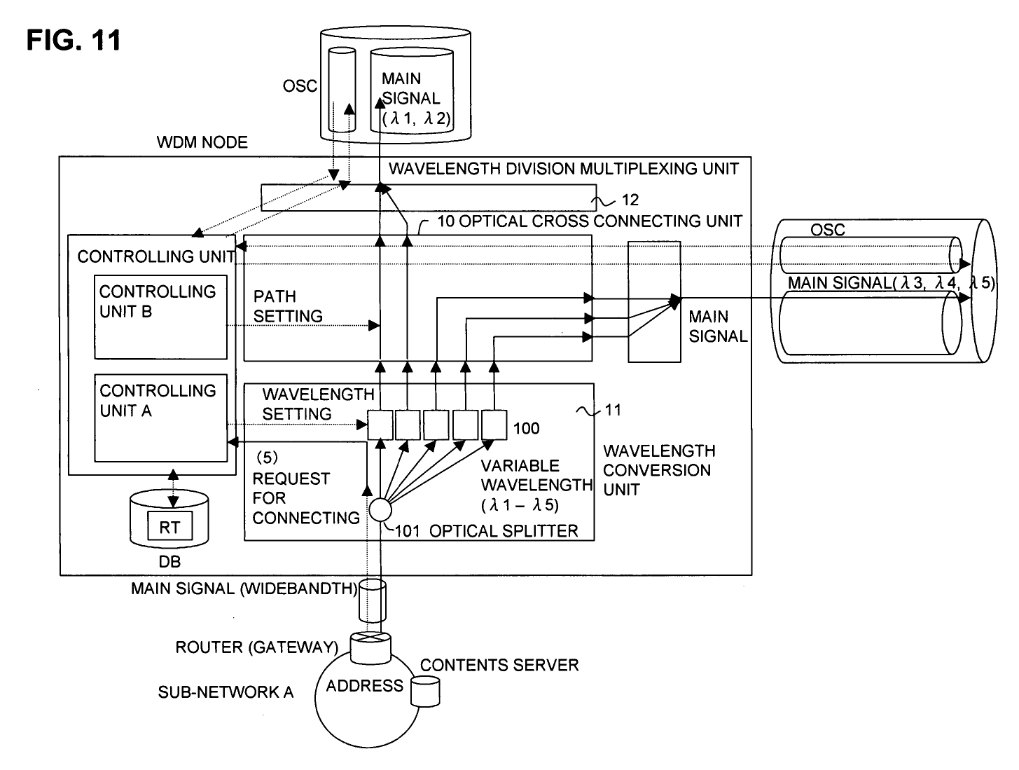

FIG. 11 shows an example of the composition of a WDM node enabling one-to-multiple communication to which the present invention is applied.

As the characteristic of this aspect, an optical splitter 101 is inserted immediately before the variable-wavelength light source 100 in the wavelength conversion unit 11 in the WDM node. Thereby, traffic from a client in the sub-network A is split and inputted into the plurality of variable-wavelength light source 100 by the optical splitter 101.

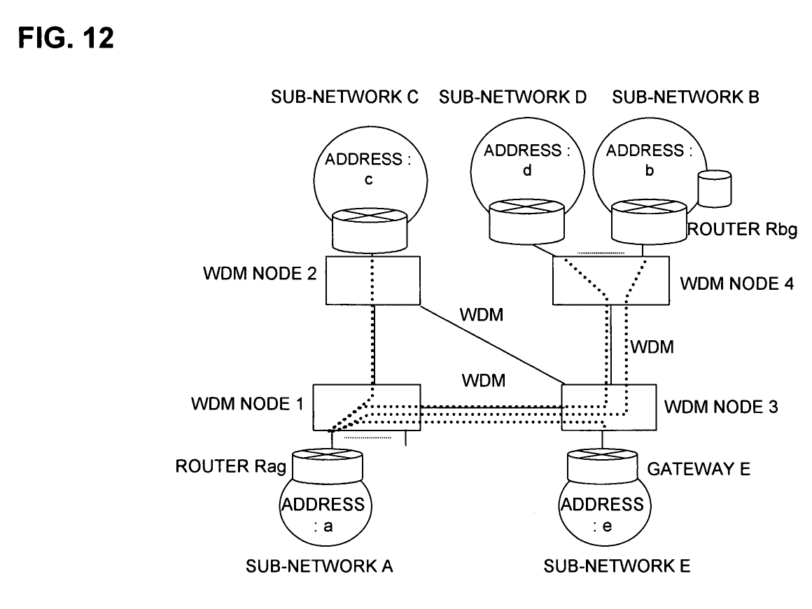

On the other hand, by addresses contained in the request for connecting (see Step 5) notified from the client, the controlling unit A of the controlling unit 13 determines the connection is of a plurality of addresses (broadcasting or multicasting) and sets wavelengths for the plurality of variable-wavelength light sources 100. Furthermore, the controlling unit B sets cross-connection with a plurality of destinations at the cross-connecting unit 10. Thereby, as shown in FIG. 12, the sub-network A can make one (1)-to-multiple communication with the sub-networks C-E.

(b) Multiple-to-Multiple Communication

Multiple-to-multiple communication is possible by executing the setting and releasing of wavelengths in a very short time in response to occurrence and disappearance of traffic directed to a plurality of addresses from a plurality of clients by combining the above [Defining and Deleting of Wavelength and Path in Response to Occurrence and Disappearance of Traffic] and (a) one (1)-to-multiple communication.

[Selection in Response to the Physical Conditions of Routes (Paths)]

Here, there are times when a path snaps during communication due to snapping of an optical fiber, failure of a WDM node, etc. A method according to the present invention, for coping with this will be described as follows.

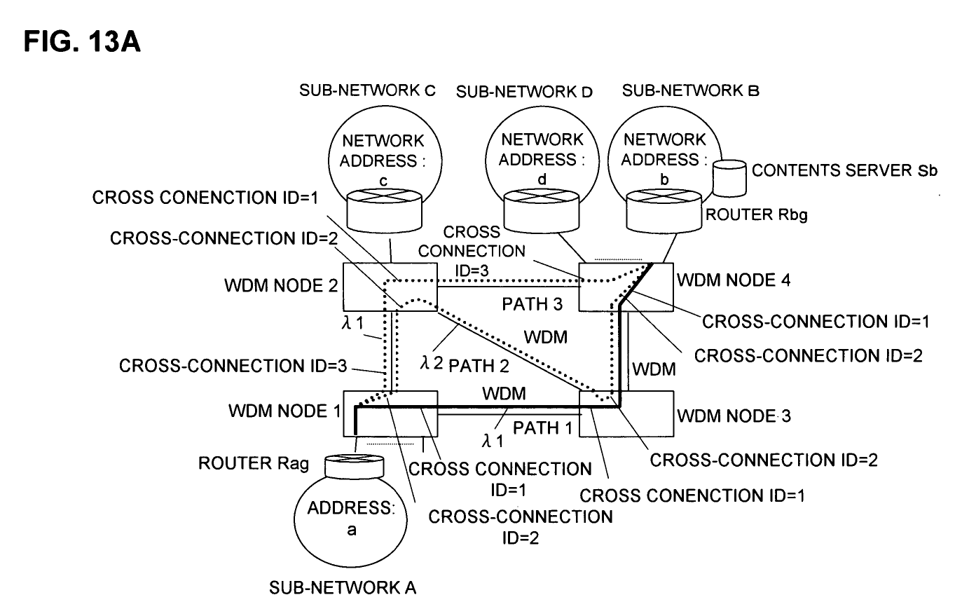

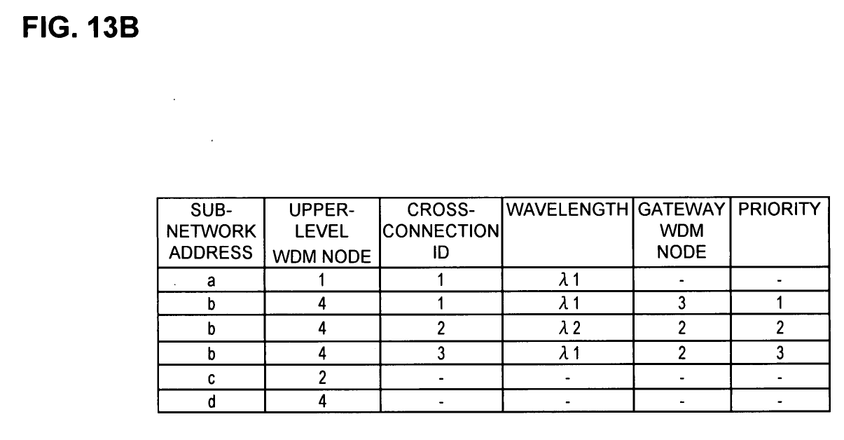

In the case where three (3) routes (Path 1, Path 2 and Path 3) can be considered as paths between the sub-networks A and B as shown in FIG. 13A, a WDM node stores these three (3) routes in the routing table RT giving them priorities.

FIG. 13B shows an example of the routing table RT of the WDM node 1 storing three (3) routes giving them priorities. The priorities are given in the order of cross-connection ID (path) 1, 2 and 3.

As the grounds of such giving of priorities, in addition to the number of WDM nodes passed through to the destination sub-network, the quality of the WDM signal at the receiving terminal (the physical condition of the path (the value of the signal/noise ratio, the value of dispersion) and the quality at the receiving terminal predicted based on how many waves are multiplexed there already) can be considered.

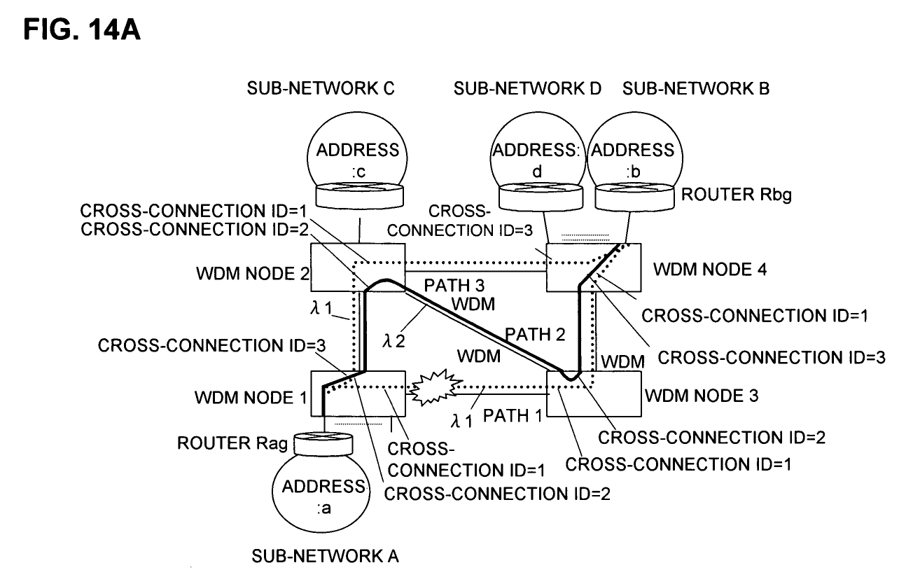

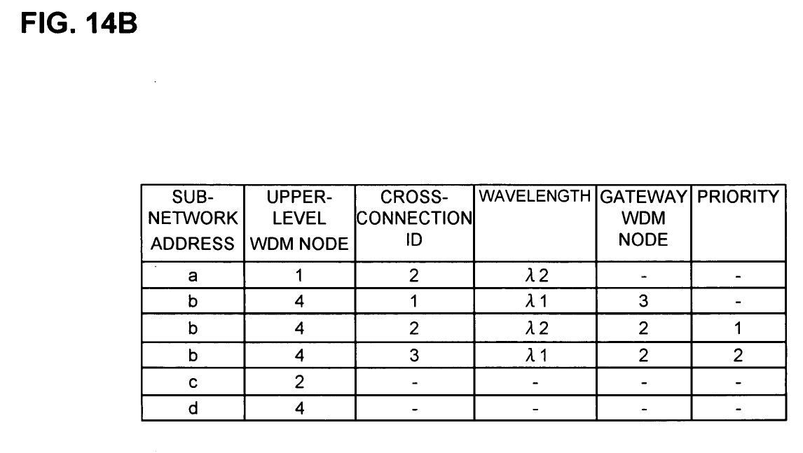

Here, the case where a failure has occurred in a path is considered. FIG. 14A shows the case where a failure has occurred in the path 1 and the path 1 is disconnected, due to a failure between the WDM node 1 and the WDM node 3 in the network composition shown in FIG. 13A.

In this case, the communication between the sub-networks A and B can be continued by switching the path 1 having the failure to the path 2 having the next-highest priority according to the routing table shown in FIG. 13B. In this case, the routing table RT is updated as shown in FIG. 14B and the priority of the path 2 becomes the highest one.

As described above, according to the present invention, each WDM node retains a plurality of paths for communication between the same transmitting and receiving clients, in a routing table giving them priorities and, thereby, a reliable network capable of continuing communication by switching the present path to another path when the present path has been disconnected can be realized.

According to the present invention, autonomous setting of wavelengths/paths in response to the use status of wavelengths and the physical conditions becomes possible and, therefore, speedy and efficient utilization of networks in cooperation with its client in its territory against the data traffic changing every moment.

Furthermore, since one (1)-to-multiple and multiple-to-multiple communication becomes possible, creation of new services such as broadcasting and interactive communication utilizing the ultra-large capacity of the WDM in the age of multimedia can be expected.

What is claimed is:

1. A WDM network system comprising:
an optical wavelength division multiplexed (WDM) transmission path;
a plurality of sub-networks each accommodating a client; and
a plurality of WDM nodes each corresponding to each of the plurality of sub-networks respectively and connected with the optical wavelength division multiplexed transmission path, wherein
each of the plurality of WDM nodes includes:
a wavelength converting unit for controlling oscillation frequencies in conformity with a destination address for which the communication destination is identified by an IP address; and
a cross-connecting unit for cross-connecting the route directed to an adjacent WDM node for connecting with the communication destination.

2. The WDM network system according to claim 1, wherein
each of the WDM nodes includes a routing table for storing the IP address of the corresponding sub-network, a WDM node of an upper order of the sub-network, a cross-connection ID identifying the path, a wavelength used and information of the WDM node to which the main signal is first sent when reaching the target sub-network using a predetermined path, and wherein
the control of the oscillation frequency by the wavelength converting unit and the cross-connecting of the route are conducted by referring to the routing table.

3. The WDM network system according to claim 2, wherein
when an IP address of a sub-network in which a client is accommodated is notified from the client issuing a request for connection, the corresponding node registers the IP address of the sub-net work into the routing table, and wherein
each WDM node exchanges the IP address information of the sub-network retained in the routing table with adjacent nodes.

4. The WDM network system according to claim 1, wherein
the oscillation of wavelengths and the settings of cross-connection are started/ended and defined/erased in response to the occurrence/disappearance of traffic from the sub-network.

5. The WDM network system according to claim 1, wherein
the wavelength converting unit executes one-to-multiple communication by converting a wavelength into a plurality of wavelengths in response to a request for connection from one (1) client.

6. The WDM network system according to claim 2, wherein
a plurality of selectable paths are set in a cross-connection ID identifying the path of the routing table, with the priority being registered for each path.

7. The WDM network system according to claim 6, wherein
the priority is set based on the quality of the WDM signal at the receiving terminal and can be updated in response to disconnection or recovery of the path.

8. A WDM node, a plurality of which each corresponding to a plurality of sub-networks and connected to optical wavelength division multiplexed (WDM) transmission paths in a WDM network system for connecting the plurality of sub-networks each accommodating clients, through the optical wavelength division multiplexed transmission paths,
the WDM node comprising:
a wavelength converting unit for controlling an oscillation frequency in conformity with the destination address by which the communication destination is identified by an IP address; and
a cross-connecting unit for cross-connecting a route directed to an adjacent WDM node for connecting with the communication destination.

9. The WDM node according to claim 8, further comprising
a routing table for storing the IP address of the corresponding sub-network, a WDM node of an upper order of the sub-network, a cross-connection ID identifying the path, a wavelength used and information of the EDM node to which the main signal is first sent when reaching the target sub-network using a predetermined path, and wherein
the control of the oscillation frequency by the wavelength converting unit and the cross-connecting of the route are conducted by referring to the routing table.

10. The WDM node according to claim 9, wherein
when an IP address of a sub-network in which a client is accommodated is notified from the client issuing a request for connection, the WDM node registers the IP address of the sub-net work into the routing table, and wherein
the WDM node exchanges the IP address information of the sub-network retained in the routing table with adjacent nodes.

11. The WDM node according to claim 8, wherein
the wavelength converting unit executes one-to-multiple communication by converting a wavelength into a plurality of wavelengths in response to a request for connection from one (1) client.

12. The WDM node according to claim 8, wherein
the oscillation of wavelengths and the settings of cross-connection are started/ended and defined/erased in response to the occurrence/disappearance of traffic from the sub-network.

13. The WDM node according to claim 9, wherein
a plurality of selectable paths are set in a cross-connection ID identifying the path of the routing table, with the priority being registered for each path.

14. The WDM node according to claim 13, wherein
the priority is set based on the quality of the WDM signal at the receiving terminal and can be updated in response to disconnection or recovery of the path.
